(19) United States
(12) Patent Application Publication
(10) Pub. No.: US 2021/0350177 A1
(43) Pub. Date: Nov. 11, 2021

(54) NETWORK TRAINING METHOD AND DEVICE AND STORAGE MEDIUM

(71) Applicant: BEIJING SENSETIME TECHNOLOGY DEVELOPMENT CO., LTD., Beijing (CN)

(72) Inventors: Dongzhan ZHOU, Beijing (CN); Maoqing TIAN, Beijing (CN); Xinchi ZHOU, Beijing (CN); Shuai YI, Beijing (CN); Wanli OUYANG, Beijing (CN)

(73) Assignee: BEIJING SENSETIME TECHNOLOGY DEVELOPMENT CO., LTD., Beijing (CN)

(21) Appl. No.: 17/384,655

(22) Filed: Jul. 23, 2021

Related U.S. Application Data
(63) Continuation of application No. PCT/CN2020/087327, filed on Apr. 27, 2020.

(30) Foreign Application Priority Data
Jan. 21, 2020 (CN) 202010071508.6

(51) Int. Cl. G06K 9/62; G06K 9/46; G06N 3/08

(52) U.S. Cl. CPC G06K 9/6256; G06K 9/46; G06K 9/6262; G06N 3/08; G06K 9/6255; G06K 9/6215; G06K 9/6261

(57) ABSTRACT

The present disclosure relates to a network training method and device, an image processing method and device, the method comprising: performing pixel shuffling on a first image in a training set to obtain a second image, wherein the first image is an image subjected to pixel shuffling; performing, by a feature extraction network of a neural network, feature extraction on the first image to obtain a first image feature, and performing, by a feature extraction network, feature extraction on the second image to obtain a second image feature; performing, by a recognition network of the neural network, recognition on the first image feature to obtain a recognition result of the first image; and training the neural network according to the recognition result, the first image feature and the second image feature. Embodiments of the present disclosure enable improvement of recognition precision of neural networks.

### CROSS-REFERENCE TO RELATED APPLICATION

The present application is a continuation of and claims the priority under 35 U.S.C. § 120 to PCT Application No. PCT/CN2020/087327, filed on Apr. 27, 2020, which claims the priority to Chinese Patent Application No. 202010071508.6 filed with China National Intellectual Property Administration, on Jan. 21, 2020, entitled “NETWORK TRAINING METHOD AND DEVICE, IMAGE PROCESSING METHOD AND DEVICE”. All the above referenced priority documents are incorporated herein by reference in their entireties.

### TECHNICAL FIELD

The present disclosure relates to the technical field of computer, in particular to a network training method and device and an image processing method and device.

### BACKGROUND

As the call for privacy protection increases gradually, in order to conduct research and development on the premise of privacy protection, data anonymization becomes inevitable.

In the related technology, the existing data set anonymization method mainly relate to human face that is the most sensitive region in images or videos. However, although human face is one of the most important privacy information, it does not constitute the entire privacy information. In fact, any information enabling directly or indirectly locating personal identity can be deemed as a part of personal privacy information.

However, if all information in an image is subjected to pixel shuffling to perform data anonymization, although privacy information can be effectively protected, the recognition precision of the neural network will decrease as a result.

### SUMMARY

The present disclosure proposes a technical solution for network training to improve the recognition precision of the neural network.

According to one aspect of the present disclosure, provided is a network training method, the method comprising:

performing pixel shuffling on a first image in a training set to obtain a second image, wherein the first image is an image subjected to pixel shuffling;

performing, by a feature extraction network of a neural network, feature extraction on the first image to obtain a first image feature, and performing, by a feature extraction network, feature extraction on the second image to obtain a second image feature;

performing, by a recognition network of the neural network, recognition on the first image feature to obtain a recognition result of the first image; and

training the neural network according to the recognition result, the first image feature and the second image feature.

According to one aspect of the present disclosure, provided is a network training device, comprising: a processor; a memory configured to store processor executable instructions; wherein the processor is configured to invoke instructions stored in the memory to execute the afore-described method.

According to one aspect of the present disclosure, provided is a non-transitory computer readable storage medium storing computer program instructions thereon, wherein when the computer program instructions are executed by a processor, the processor is caused to perform the afore-described method.

In such manner, according to the network training method and device and the image processing method and device provided by the embodiments of the present disclosure, the first image subjected to pixel shuffling in the training set may be subjected to pixel shuffling again, to obtain the second image; and the first image feature corresponding to the first image and the second image feature corresponding to the second image are obtained by performing, by the feature extraction network, feature extraction on the first image and the second image. Further, the recognition result of the first image may be obtained by performing, by the recognition network, recognition on the first image feature; and the neural network may be trained according to the recognition result, the first image feature and the second image feature.

It is appreciated that the foregoing general description and the subsequent detailed description are merely exemplary and illustrative and do not limit the present disclosure. Additional features and aspects of the present disclosure will become apparent from the following detailed description of exemplary embodiments with reference to the attached drawings.

### BRIEF DESCRIPTION OF THE DRAWINGS

The drawings, which are incorporated in and constitute part of the specification, illustrate embodiments according to the present disclosure, and serve to explain the technical solutions of the present disclosure together with the description.

FIG. 1 shows a flow chart of the network training method according to an embodiment of the present disclosure.

FIG. 2 shows a schematic diagram of the network training method according to an embodiment of the present disclosure.

FIG. 3 shows a schematic diagram of the network training method according to an embodiment of the present disclosure.

FIG. 4 shows a block diagram of the network training device according to an embodiment of the present disclosure.

FIG. 5 shows a block diagram of an electronic apparatus 800 according to an embodiment of the present disclosure.

FIG. 6 shows a block diagram of an electronic apparatus 1900 according to an embodiment of the present disclosure.

### DETAILED DESCRIPTION

Various exemplary embodiments, features and aspects of the present disclosure will be described in detail with reference to the drawings. The same reference numerals in the drawings represent elements having the same or similar functions. Although various aspects of the embodiments are shown in the drawings, it is unnecessary to proportionally draw the drawings unless otherwise specified.

Herein the term “exemplary” means “used as an instance or embodiment, or explanatory”. An “exemplary” embodiment given here is not necessarily construed as being superior to or better than other embodiments.

Herein the term “and/or” only describes an association relation between associated objects and indicates three possible relations. For example, the phrase “A and/or B” may indicate a case where only A is present, a case where A and B are both present, and a case where only B is present. In addition, the term “at least one” herein indicates any one of a plurality or a random combination of at least two of a plurality. For example, including at least one of A, B and C may mean including any one or more elements selected from a set consisting of A, B and C.

In addition, numerous specific details are given in the following specific embodiments for the purpose of better explaining the present disclosure. It should be understood by a person skilled in the art that the present disclosure can still be realized even without some of those specific details. In some of the instances, methods, means, elements and circuits that are well known to a person skilled in the art are not described in detail so that the principle of the present disclosure become apparent.

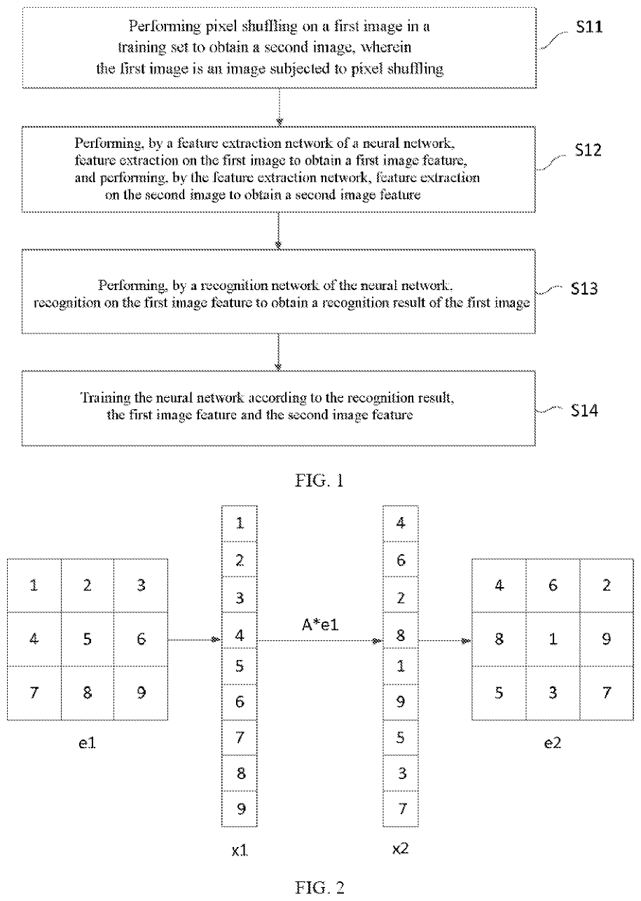

FIG. 1 shows a flow chart of the network training method according to an embodiment of the present disclosure. The network training method may be executed by an electronic apparatus such as a terminal apparatus or a server. The terminal apparatus may be a user equipment (UE), a mobile apparatus, a user terminal, a terminal, a cellular phone, a cordless phone, a Personal Digital Assistant (PDA), a handheld apparatus, a computing apparatus, a vehicle on-board apparatus, a wearable apparatus, etc. The method may be implemented by invoking, by a processor, computer readable instructions stored in a memory. Or, the method may be executed by a server.

In the field such as pedestrian re-identification and security, neural networks play an increasingly important role. For example, neural networks can be used for face recognition and identity authentication etc., and the labor costs can be reduced greatly by neural networks. However, the training process of the neural network requires incredibly rich sample images containing various personal information. For privacy protection, the sample images may be subjected to data anonymization. However, if data anonymization is performed by subjecting all information contained in the images through pixel shuffling, although private information can be effectively protected, the recognition precision of the neural network will be caused to decrease.

The present disclosure proposes a network training method which may increase the recognition precision of the trained neural network with respect to sample images subjected to data anonymization by pixel shuffling.

As illustrated in FIG. 1, the network training method may include the following.

Step S11, performing pixel shuffling on a first image in a training set to obtain a second image, wherein the first image is an image subjected to pixel shuffling.

For example, a neural network may be trained using a preset training set, the neural network including a feature extraction network for feature extraction and a recognition network for image recognition. The training set includes a plurality of first image, wherein the first image may be an image obtained by subjecting the original image to pixel shuffling, and the first image has a labelling result. The above original image may be a human image collected by an imaging apparatus. For example, in a scenario of pedestrian re-identification, the original image may be an image of a pedestrian captured by an imaging apparatus.

For the first image in the training set, position transformation may be performed on pixel points of the first image, so as to perform pixel shuffling to obtain the second image. It should be noted that, in the present application, the method of the pixel shuffling performed on the first image is the same with the process of performing pixel shuffling on the original image to obtain the first image.

Step S12, performing, by a feature extraction network of a neural network, feature extraction on the first image to obtain a first image feature, and performing, by the feature extraction network, feature extraction on the second image to obtain a second image feature.

For example, after obtaining the second image, the first image and the second image may be input into the feature extraction network for feature extraction, respectively, to obtain the first image feature corresponding to the first image and the second image feature corresponding to the second image.

Step S13, performing, by a recognition network of the neural network, recognition on the first image feature to obtain a recognition result of the first image.

For example, the first image feature may be input into the recognition network to be recognized to obtain a recognition result corresponding to the first image. The recognition network may be a convolutional neural network. The present disclosure does not limit the specific implementation of the recognition network.

Step S14, training the neural network according to the recognition result, the first image feature and the second image feature.

For example, since the first image and the second image are images obtained by subjecting the original to pixel shuffling once and twice, respectively, they contain exactly the same semantics. The first image feature corresponding to the first image and the second image feature corresponding to the second image which are extracted by the feature extraction network should be as similar as possible. Hence, a feature loss corresponding to the feature extraction network can be obtained through the first image feature and the second image feature, and a recognition loss corresponding to the recognition network can be obtained according to the recognition result corresponding to the first image. Further according to the feature loss and the recognition loss, it is possible to adjust the network parameters of the neural network to train the neural network.

In such manner, according to the network training method provided by the embodiments of the present disclosure, the first image in the training set which is obtained by performing pixel shuffling is subjected to pixel shuffling again, thereby obtaining the second image; the first image feature corresponding to the first image and the second image feature corresponding to the second image are obtained by performing, by the feature extraction network, feature extraction on the first image and the second image. Further, the recognition result of the first image may be obtained by performing, by the recognition network, recognition on the first image feature; the neural network may be trained according to the recognition result, the first image feature and the second image feature. According to the network training method provided by the embodiments of the present disclosure, by training the neural network using the first image subjected to pixel shuffling and the second image obtained by further pixel shuffling the first image, it is possible to improve the feature extraction precision of the neural network and enable the neural network to extract effective features from the image subjected to pixel shuffling, thereby improving the recognition precision for the first image subjected to data anonymization by pixel shuffling.

In a possible embodiment, training the neural network according to the recognition result, the first image feature and the second image feature may include:

determining a recognition loss according to the recognition result and a labelling result corresponding to the first image;

determining a feature loss according to the first image feature and the second image feature; and

training the neural network according to the recognition loss and the feature loss.

For example, the recognition loss may be determined through the labelling result corresponding to the first image and the recognition result corresponding to the first image; and the feature loss may be determined according to the first image feature and the second image feature.

In a possible embodiment, obtaining the feature loss according to the first image feature and the second image feature may include:

determining a distance between the first image feature in the first image and the second image feature in the second image as the feature loss.

By the feature loss, the first image feature and the second image feature extracted by the feature extraction network may be urged to be similar, so as to enable the neural network to always extract effective features with respect to images subjected to pixel shuffling, thereby improving the precision of feature extraction of the neural network. Exemplarily, the feature loss may be determined by the following Equation I.

$${L}_{2} ( {f}_{n}^{s} , {f}_{n}^{r} ) = {‖ \frac{{f}_{n}^{s}}{{‖ {f}_{n}^{s} ‖}_{2}} - \frac{{f}_{n}^{r}}{{‖ {f}_{n}^{r} ‖}_{2}} ‖}_{2} \qquad Equation I$$

wherein fₙ^{s} indicates the first image feature of an nth first image, fₙ^{r} indicates the second image feature of an nth second image, and L₂(fₙ^{s},fₙ^{r}) indicates the feature loss.

In a possible embodiment, performing pixel shuffling on a first image in a training set to obtain a second image may include:

dividing the first image into a preset number of pixel blocks;

for any one of the pixel blocks, shuffling a position of each pixel point in the pixel block to obtain the second image.

For example, the above-mentioned preset number may be a preset number value. The value of the preset number may beset as needed or may be determined according to the preset pixel block size. The embodiments of the present disclosure do not specifically limit the value of the preset number.

The first image may be subjected to pre-processing to divide the first image into a preset number of pixel blocks and, for each pixel block, perform position transformation among pixel points to obtain the second image.

In a possible embodiment, for any one of the pixel blocks, shuffling the position of each pixel point in the pixel block includes:

for any one of the pixel blocks, performing position transformation on pixel points in the pixel block according to a preset row transformation matrix, the row transformation matrix being an orthogonal matrix.

The pixel block and the preset row transformation matrix may be multiplied to transform the position of each pixel point in the pixel block, thereby realizing pixel shuffling in the pixel block. Since the preset row transformation matrix is an orthogonal matrix, it has an inverse matrix, therefore the operation performed according to the preset row transformation matrix is one-step invertible. That is, although the second image after pixel shuffling according to the preset row transformation matrix and the first image have different spatial structure, they carry closely correlated image information therebetween. Hence, it is possible to train the neural network by the first image feature and the second image feature extracted from the first image and the second image such that the first image feature of the first image and the second image feature of the second image extracted by the neural network are as similar as possible, thereby improving the precision of feature extraction by the neural network, and further improving the recognition precision of the neural network.

For example, as shown in FIG. 2, assuming that any one pixel block is a 3*3 matrix e1, the corresponding matrix vector thereof is shown as x1 in FIG. 2. A is the preset row transformation matrix. The row transformation matrix A is multiplied by x1 to obtain the matrix vector shown as x2. The pixel block corresponding to the matrix vector x2 is shown as e2 that is a pixel block obtained by subjecting the e1 to pixel shuffling by the preset row transformation matrix.

In a possible embodiment, training the neural network according to the recognition loss and the feature loss may include:

determining a total loss according to a weighted sum of the recognition loss and the feature loss; and

training the neural network according to the total loss.

For example, the weighted sum of the recognition loss and the feature loss may be determined as the total loss of the neural network, wherein the weights corresponding to the recognition loss and the feature loss may be set as needed, which is not limited in the present disclosure. The parameter of the neural network may be adjusted according to the total loss, including adjusting the parameter of the feature extraction network and the parameter of the recognition network till the total loss satisfies a training precision. For example, when the total loss is less than a threshold value, the training of the neural network is completed.

To help those skilled in the art to better understand the embodiments of the present disclosure, the embodiments of the present disclosure are explained below with reference to specific examples.

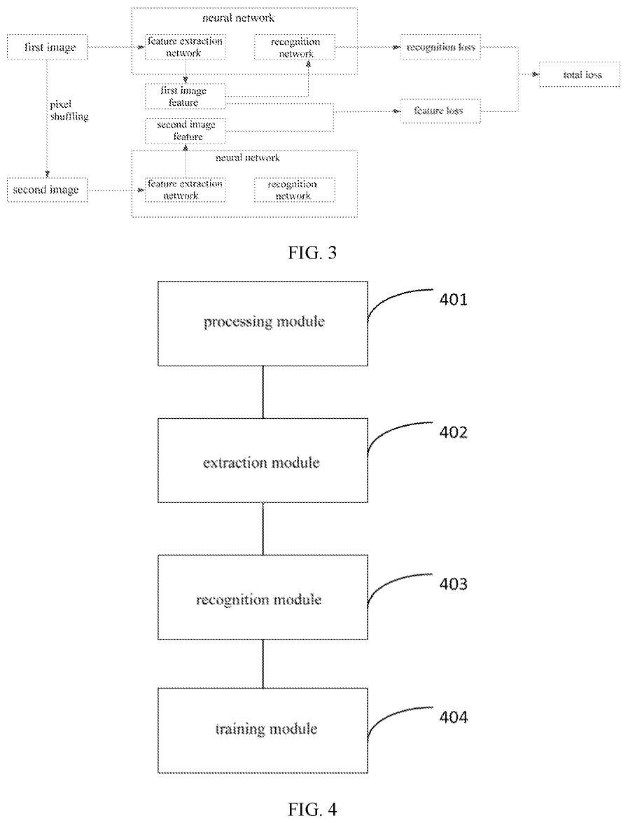

As shown in FIG. 3, the second image may be obtained by performing pixel shuffling on the first image. The first image and the second image are respectively input into the feature extraction network of the neural network, thereby obtaining the first image feature of the first image and the second image feature of the second image. The first image feature is input into the recognition network to obtain the recognition result of the first image. The recognition loss may be obtained according to the recognition result. According to the first image feature and the second image feature, the feature loss may be obtained. The total loss of the neural network may be obtained according to the recognition loss and the feature loss. Further, the neural network may be trained according to the total loss, thereby obtaining a neural network achieving more precise recognition of images subjected to data anonymization by pixel shuffling.

The present disclosure further provides an image processing method. The image processing method may be executed by an electronic apparatus, such as a terminal apparatus or a server. The terminal apparatus may be a user equipment UE, a mobile apparatus, a user terminal, a terminal, a cellular phone, a cordless phone, a Personal Digital Assistant PDA, a handheld apparatus, a computing apparatus, a vehicle on-board apparatus, a wearable apparatus, etc. The method may be implemented by invoking, by a processor, computer readable instructions stored in a memory. Alternatively, the method may be executed by a server.

The image processing method may include: performing, by a neural network, image recognition on an image to be processed to obtain a recognition result, wherein the neural network is obtained from training by the afore-described network training method.

By means of the neural network obtained from training by the neural network training method according to the afore-described embodiments (the specific training process may be referred to in the afore-described embodiments, which will not be repeatedly described herein), it is possible to perform image recognition on an image to be processed to obtain a recognition result. In a case where the image to be processed is an image subjected to anonymization by pixel shuffling, it is possible to improve the precision of the recognition result.

According to the image processing method provided by an embodiment of the present disclosure, it is possible to perform image recognition on an image to be processed by the neural network obtained by training according to the afore-described embodiments. Since the neural network is capable of extracting effective features from images subjected to pixel shuffling, it is possible to improve the recognition precision with respect to the first image subjected to pixel shuffling. In such manner, the recognition precision of the neural network may be improved while the training samples in the training set may be subjected to data anonymization by pixel shuffling to protect privacy information.

It is appreciated that the afore-described various method embodiments of the present disclosure can be combined with each other to form combined embodiments without departing the principle and the logics. To be concise, these combined embodiments will not be described herein. A person skilled in the art may understand that the specific execution order of the steps in the afore-described methods according to the embodiments should be determined by their functions and possible inner logics.

Furthermore, the present disclosure further provides a network training device, an image processing device, an electronic apparatus, a computer readable storage medium, and a program, all of which are capable of implementing any one of the network training method and the image processing method provided by the present disclosure. The corresponding technical solution and description may refer to the corresponding description of the method and will not be repeated herein.

FIG. 4 shows a block diagram of the network training device according to an embodiment of the present disclosure. As shown in FIG. 4, the network training device comprises:

a processing module 401 capable of performing pixel shuffling on a first image in a training set to obtain a second image, wherein the first image is an image subjected to pixel shuffling;

an extraction module 402 capable of performing, by a feature extraction network of a neural network, feature extraction on the first image to obtain a first image feature, and performing, by a feature extraction network, feature extraction on the second image to obtain a second image feature;

a recognition module 403 capable of performing, by a recognition network of the neural network, recognition on the first image feature to obtain a recognition result of the first image; and

a training module 404 capable of training the neural network according to the recognition result, the first image feature and the second image feature.

In such manner, according to the network training device provided by the embodiments of the present disclosure, the first image in the training set which is obtained by performing pixel shuffling may be subjected to pixel shuffling again, thereby obtaining the second image; the first image feature corresponding to the first image and the second image feature corresponding to the second image are obtained by performing, by the feature extraction network, feature extraction on the first image and the second image. Further, the recognition result of the first image may be obtained by performing, by the recognition network, recognition on the first image feature; and the neural network may be trained according to the recognition result, the first image feature and the second image feature. According to the network training device provided by an embodiment of the present disclosure, by training the neural network using the first image subjected to pixel shuffling and the second image obtained by further pixel shuffling the first image, it is possible to improve the feature extraction precision of the neural network and enable the neural network to extract effective features from the image subjected to pixel shuffling, thereby improving the recognition precision for the first image subjected to data anonymization by pixel shuffling.

In a possible embodiment, the training module is configured further to:

determine a recognition loss according to the recognition result and a labelling result corresponding to the first image;

determine a feature loss according to the first image feature and the second image feature; and

train the neural network according to the recognition loss and the feature loss.

In a possible embodiment, the processing module is configured further to:

divide the first image into a preset number of pixel blocks;

for any one of the pixel blocks, shuffle a position of each pixel point in the pixel block to obtain the second image.

In a possible embodiment, the processing module is configured further to:

for any one of the pixel blocks, perform position transformation on pixel points in the pixel block according to a preset row transformation matrix, the row transformation matrix being an orthogonal matrix.

In a possible embodiment, the training module is configured further to:

determine a distance between the first image feature in the first image and the second image feature in the second image as the feature loss.

In a possible embodiment, the training module is configured further to:

determine a total loss according to a weighted sum of the recognition loss and the feature loss; and

train the neural network according to the total loss.

An embodiment of the present disclosure further provides an image processing device, comprising:

a recognition module configured to perform, by a neural network, image recognition on an image to be processed to obtain a recognition result,

wherein the neural network is obtained from training by any one of the afore-described network training method.

According to the image processing method provided by an embodiment of the present disclosure, image recognition may be performed on an image to be processed by the neural network obtained by training according to the afore-described embodiments. Since the neural network is capable of extracting effective features from images subjected to pixel shuffling, it is thus possible to improve the recognition precision with respect to the first image subjected to pixel shuffling. In such manner, the recognition precision of the neural network may be improved while the training samples in the training set are subjected to data anonymization by pixel shuffling to protect privacy information.

In some embodiments, functions or modules of the device provided by embodiments of the present disclosure are capable of executing the method described according to the method embodiments. The specific implementation may be referred to the description of the method embodiments, which will not be repeated herein to be concise.

Embodiments of the present disclosure further propose a computer readable storage medium storing computer program instructions thereon, which implement the afore-described method when being executed by a processor. The computer readable storage medium may be a non-volatile computer readable storage medium.

Embodiments of the present disclosure further proposes an electronic apparatus, comprising a processor; a memory configured to store processor executable instructions, wherein the processor is configured to invoke instructions stored in the memory to execute the afore-described method.

An embodiment of the present disclosure further provides a computer program product comprising computer readable codes, when the computer readable codes run on an apparatus, a processor in the apparatus execute instructions for realizing any one of the network training method and the image processing method according to the afore-described embodiments.

An embodiment of the present disclosure further provides another computer program product configured to store computer readable instructions which, when executed, causes the computer to execute any one of the network training method and the image processing method according to the afore-described embodiments.

The electronic apparatus may be provided as a terminal, a server, or an apparatus in other form.

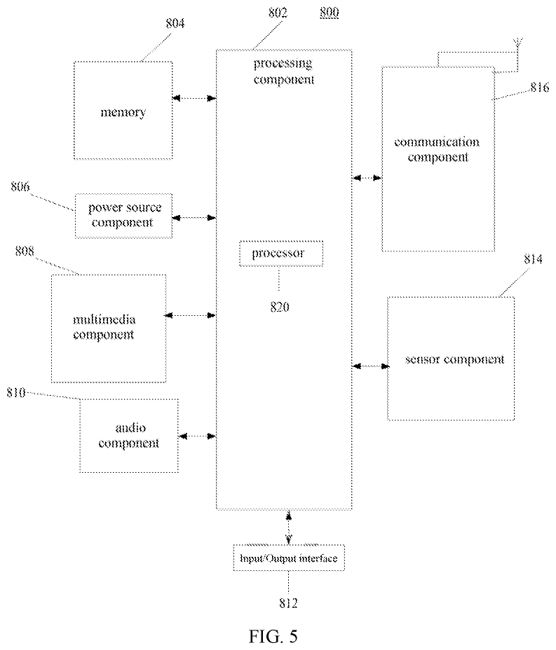

FIG. 5 shows a block diagram of an electronic apparatus 800 according to an embodiment of the present disclosure. For example, electronic apparatus 800 may be a mobile phone, a computer, a digital broadcasting terminal, a message transceiving apparatus, a game console, a tablet apparatus, medical apparatus, fitness apparatus, a personal digital assistant and the like.

Referring to FIG. 5, electronic apparatus 800 may include one or more of the following components: a processing component 802, a memory 804, a power source component 806, a multimedia component 808, an audio component 810, an input/output (I/O) interface 812, a sensor component 814, and a communication component 816.

Processing component 802 is configured to control overall operations of electronic apparatus 800, such as the operations associated with display, telephone calls, data communications, camera operations, and recording operations. Processing component 802 may include one or more processors 820 to execute instructions to complete all or part of the steps of the above-described methods. In addition, processing component 802 may include one or more modules to facilitate the interaction between the processing component 802 and other components. For example, processing component 802 may include a multimedia module to facilitate the interaction between multimedia component 808 and processing component 802.

Memory 804 is configured to store various types of data to support the operation of electronic apparatus 800. Examples of such data include instructions for any applications or methods operated on electronic apparatus 800, contact data, phonebook data, messages, pictures, video, etc. Memory 804 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power source component 806 is configured to provide power to various components of electronic apparatus 800. Power source component 806 may include a power management system, one or more power sources, and other components associated with the generation, management, and distribution of power in electronic apparatus 800.

Multimedia component 808 includes a screen providing an output interface between electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors to sense touches, slides, and gestures on the touch panel. The touch sensors may sense not only a boundary of a touch or slide action, but also a period of time and a pressure associated with the touch or slide action. In some embodiments, multimedia component 808 may include a front camera and/or a rear camera. The front camera and the rear camera may receive an external multimedia data while electronic apparatus 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 may include a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 may include one or more sensors configured to provide status assessments of various aspects for electronic apparatus 800. For example, sensor component 814 may detect an open/closed status of electronic apparatus 800, relative positioning of components, e.g., the display and the keypad of electronic apparatus 800. Sensor component 814 may further detect a change in position of electronic apparatus 800 or a component of electronic apparatus 800, a presence or absence of user contact with electronic apparatus 800, an orientation or an acceleration/deceleration of electronic apparatus 800, and a change in temperature of electronic apparatus 800. Sensor component 814 may include a proximity sensor configured to detect the presence of nearby objects without any physical contact. Sensor component 814 may also include a light sensor, such as a CMOS or CCD image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic apparatus 800 and other apparatuses. Electronic apparatus 800 can access a wireless network based on a communication standard, such as WiFi, 2G, or 3G, or a combination thereof. In an exemplary embodiment, communication component 816 receives a broadcast signal from an external broadcast management system or broadcast related information via a broadcast channel. In an exemplary embodiment, communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium, such as memory 804 including computer program instructions which are executable by processor 820 of electronic apparatus 800 to perform the above-described methods.

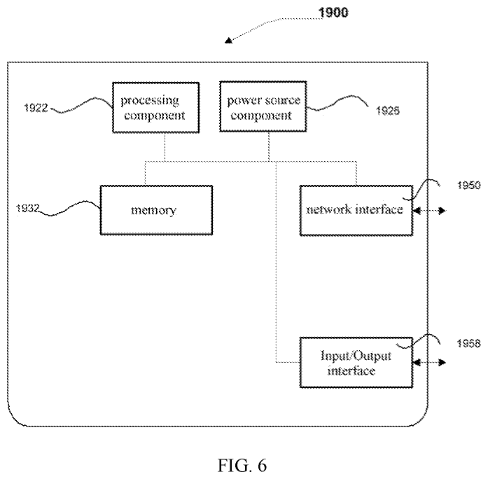

FIG. 6 shows a block diagram showing an electronic apparatus 1900 according to an embodiment of the present disclosure. For example, the electronic apparatus 1900 may be provided as a server. Referring to FIG. 6, the electronic apparatus 1900 includes a processing component 1922, which further includes one or more processors, and a memory resource represented by a memory 1932 configured to store instructions executable for the processing component 1922, such as application programs. The application programs stored in the memory 1932 may include one or more than one module each of which corresponds to a set of instructions. In addition, the processing component 1922 is configured to execute the instructions to execute the above-mentioned methods.

The electronic apparatus 1900 may further include a power source component 1926 configured to execute power management of the electronic apparatus 1900, a wired or wireless network interface 1950 configured to connect the electronic apparatus 1900 to a network, and an Input/Output (I/O) interface 1958. The electronic apparatus 1900 may be operated on the basis of an operating system stored in the memory 1932, such as Window Server™, Mac OS X™, Unix™, Linux™ or Free BSD™ or similar.

In an exemplary embodiment, there is also provided a non-transitory computer readable storage medium, such as memory 1932 including computer program instructions, which are executable by processing component 1922 of apparatus 1900 to perform the above-described methods.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible apparatus that can retain and store instructions used by an instruction executing apparatus. The computer readable storage medium may be, but not limited to, e.g., electronic storage apparatus, magnetic storage apparatus, optical storage apparatus, electromagnetic storage apparatus, semiconductor storage apparatus, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded apparatus (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing apparatuses from a computer readable storage medium or to an external computer or external storage apparatus via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium in the respective computing/processing apparatuses.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Each block in the flowchart and/or the block diagrams of the method, device (systems), and computer program product according to the embodiments of the present disclosure, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other apparatuses to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other apparatuses to have a series of operational steps performed on the computer, other programmable devices or other apparatuses, so as to produce a computer implemented process, such that the instructions executed on the computer, other programmable devices or other apparatuses implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions

The computer program product may be specifically implemented by hardware, software, or a combination thereof. In an optional embodiment, the computer program product is specifically implemented as a computer storage medium. In another optional embodiment, the computer program product is specifically implemented as a software product, such as a Software Development Kit (SDK), etc.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A network training method, comprising:
performing pixel shuffling on a first image in a training set to obtain a second image, wherein the first image is an image subjected to pixel shuffling;
performing, by a feature extraction network of a neural network, feature extraction on the first image to obtain a first image feature, and performing, by the feature extraction network, feature extraction on the second image to obtain a second image feature;
performing, by a recognition network of the neural network, recognition on the first image feature to obtain a recognition result of the first image; and
training the neural network according to the recognition result, the first image feature and the second image feature.

2. The method according to claim 1, wherein training the neural network according to the recognition result, the first image feature and the second image feature comprises:
determining a recognition loss according to the recognition result and a labelling result corresponding to the first image;
determining a feature loss according to the first image feature and the second image feature; and
training the neural network according to the recognition loss and the feature loss.

3. The method according to claim 1, wherein performing pixel shuffling on the first image in the training set to obtain the second image comprises:
dividing the first image into a preset number of pixel blocks; and
for any one of the pixel blocks, shuffling a position of each pixel point in the pixel block to obtain the second image.

4. The method according to claim 3, wherein for any one of the pixel block, shuffling the position of each pixel point in the pixel block comprises:
for any one of the pixel blocks, performing position transformation on pixel points in the pixel block according to a preset row transformation matrix, the row transformation matrix being an orthogonal matrix.

5. The method according to claim 2, wherein obtaining the feature loss according to the first image feature and the second image feature comprises:
determining a distance between the first image feature in the first image and the second image feature in the second image as the feature loss.

6. The method according to claim 2, wherein training the neural network according to the recognition loss and the feature loss comprises:
determining a total loss according to a weighted sum of the recognition loss and the feature loss; and
training the neural network according to the total loss.

7. The method according to claim 1, further comprising:
performing, by the trained neural network, image recognition on an image to be processed to obtain a recognition result of the image to be processed.

8. A network training device, comprising:
a processor; and
a memory configured to store processor executable instructions;
wherein the processor is configured to invoke instructions stored by the memory, so as to:
perform pixel shuffling on a first image in a training set to obtain a second image, wherein the first image is an image subjected to pixel shuffling;
perform, by a feature extraction network of a neural network, feature extraction on the first image to obtain a first image feature, and perform, by the feature extraction network, feature extraction on the second image to obtain a second image feature;
perform, by a recognition network of the neural network, recognition on the first image feature to obtain a recognition result of the first image; and
train the neural network according to the recognition result, the first image feature and the second image feature.

9. The network training device according to claim 8, wherein training the neural network according to the recognition result, the first image feature and the second image feature comprises:
determining a recognition loss according to the recognition result and a labelling result corresponding to the first image;
determining a feature loss according to the first image feature and the second image feature; and
training the neural network according to the recognition loss and the feature loss.

10. The network training device according to claim 8, wherein performing pixel shuffling on the first image in the training set to obtain the second image comprises:
dividing the first image into a preset number of pixel blocks; and
for any one of the pixel blocks, shuffling a position of each pixel point in the pixel block to obtain the second image.

11. The network training device according to claim 10, wherein for any one of the pixel blocks, shuffling the position of each pixel point in the pixel block comprises:
for any one of the pixel blocks, performing position transformation on pixel points in the pixel block according to a preset row transformation matrix, the row transformation matrix being an orthogonal matrix.

12. The network training device according to claim 9, wherein obtaining the feature loss according to the first image feature and the second image feature comprises:
determining a distance between the first image feature in the first image and the second image feature in the second image as the feature loss.

13. The network training device according to claim 9, wherein training the neural network according to the recognition loss and the feature loss comprises:
determining a total loss according to a weighted sum of the recognition loss and the feature loss; and
training the neural network according to the total loss.

14. The network training device according to claim 8, wherein the processor is further configured to:
perform, by the trained neural network, image recognition on an image to be processed to obtain a recognition result of the image to be processed.

15. A non-transitory computer readable storage medium storing computer program instructions, wherein when the computer program instructions are executed by a processor, the processor is caused to perform the operations of:
performing pixel shuffling on a first image in a training set to obtain a second image, wherein the first image is an image subjected to pixel shuffling;
performing, by a feature extraction network of a neural network, feature extraction on the first image to obtain a first image feature, and performing, by the feature extraction network, feature extraction on the second image to obtain a second image feature;
performing, by a recognition network of the neural network, recognition on the first image feature to obtain a recognition result of the first image; and
training the neural network according to the recognition result, the first image feature and the second image feature.

16. The method according to claim 15, wherein training the neural network according to the recognition result, the first image feature and the second image feature comprises:
determining a recognition loss according to the recognition result and a labelling result corresponding to the first image;
determining a feature loss according to the first image feature and the second image feature; and
training the neural network according to the recognition loss and the feature loss.

17. The method according to claim 15, wherein performing pixel shuffling on the first image in the training set to obtain the second image comprises:
dividing the first image into a preset number of pixel blocks; and
for any one of the pixel blocks, shuffling a position of each pixel point in the pixel block to obtain the second image.

18. The method according to claim 17, wherein for any one of the pixel blocks, shuffling the position of each pixel point in the pixel block comprises:
for any one of the pixel blocks, performing position transformation on pixel points in the pixel block according to a preset row transformation matrix, the row transformation matrix being an orthogonal matrix.

19. The method according to claim 16, wherein obtaining the feature loss according to the first image feature and the second image feature comprises: determining a distance between the first image feature in the first image and the second image feature in the second image as the feature loss;
or,
wherein training the neural network according to the recognition loss and the feature loss comprises: determining a total loss according to a weighted sum of the recognition loss and the feature loss; and training the neural network according to the total loss.

20. The method according to claim 15, wherein the processor is further caused to perform, by the trained neural network, image recognition on an image to be processed to obtain a recognition result of the image to be processed.
